(19) United States
(12) Patent Application Publication
(10) Pub. No.: US 2017/0020788 A1
(43) Pub. Date: Jan. 26, 2017

(54) Lullaby Pacifier

(71) Applicant: Elizabeth Malone, Crane, TX (US)

(72) Inventor: Elizabeth Malone, Crane, TX (US)

(21) Appl. No.: 14/806,652

(22) Filed: Jul. 23, 2015

(51) Int. Cl. A61J 17/00; H04R 1/02

(52) U.S. Cl. CPC A61J 17/008; A61J 17/002; H04R 1/028; H04R 2420/07

(57) ABSTRACT

The invention disclosure relates to a baby pacifier. The pacifier disclosed herein has a built-in memory system, Bluetooth device, audio system, and control switch. The pacifier is meant for imparting soothing and comforting feelings to the child once it uses the pacifier via an audio system. The pacifier, once activated, is capable of producing music, stories, poems, and a parent's voice via the audio system. The pacifier increases the learning capabilities of a child through the activation of the auditory stimulus.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention disclosure generally relates to a baby pacifier. More particularly, this invention relates to a pacifier that has a built-in memory and Bluetooth device to help normal infants learn music and language, and to facilitate activation of an auditory stimulus via an audio system that is integrated into the pacifier.

(2) Background of the Invention

A pacifier is a rubber, plastic, or silicone nipple that is given to an infant or other young child to suck. In its standard appearance, it has a teat, mouth shield, and handle. The mouth shield and/or the handle are large enough to avoid the danger of the child choking on it or swallowing it.

Pacifiers were cited for the first time in medical literature in 1473. They were described by the German physician Bartholomäus Metlinger in his book Kinderbüchlein, retitled on later editions as “Regiment der jungen Kinder” (A Guide on Young Children).

In England, the original “pacifier” was actually a corn on the cob, which was found to soothe a young baby by the wife of a farmer in 1680s. The corn cob worked as a nice replacement for the mother's sore nipple, and it helped the baby to relax and fall asleep. In England in the 17th-19th centuries, a coral meant a teething toy made of coral, ivory or bone that was often mounted in silver as the handle of a rattle.

There exist numerous prior arts that disclose pacifiers with various embodiments that have varied functions.

U.S. Pat. No. 5,662,685 A, discloses a sound-producing pacifier that produces sound to comfort an infant. However, this prior art does not have the option of changing the sound or switching to a new sound after a period of time.

Another prior art. U.S. Pat. No. 5,830,235 A, discloses a pacifier wherein the pacifier system activates a sound source, such as a music source, once sucking of a minimum intensity has been detected for a minimum period of time. This prior art is more focused in detecting the child's health through the pacifier attached to the intensity monitoring system.

Furthermore, prior art US patent 20070255661 A1 discloses a flavored nipple with a pacifier device. It is equipped with a memory chip that can play music or educational material, such as the ABCs or 123s, to a child while the child is using the pacifier. A power source and the necessary electrical connections are included, as well as a small speaker for sound. However, this prior art requires the removal of the chip for insertion of any new data to be played on the pacifier.

All of the above-mentioned prior arts, and other existing prior arts, have focused on various aspects and improvements that can be incorporated into pacifiers. The current invention disclosure is a completely different pacifier that has an integrated built-in memory as well as a Bluetooth device. The current invention pacifier provides instant comfort to the child, and also facilitates child's learning through the integrated audio system that is capable of producing the user's chosen data, such as music, stories, poems, etc.

### SUMMARY OF THE INVENTION

In view of the foregoing disadvantages inherent in the known types of pacifiers and their various embodiments and assemblies present in the prior art, the present invention provides an improved pacifier that has a built-in Bluetooth and memory device. As such, the general purpose of the present invention, which will be described subsequently in greater detail, is to provide a new and improved pacifier that has all of the advantages of the prior art baby pacifiers and assemblies, and none of the disadvantages.

The following summary is provided to facilitate an understanding of some of the innovative features that are unique to the disclosed embodiment, and is not intended to be a full description. A full appreciation of the various aspects of the embodiments disclosed herein can be gained by taking the entire specification, claims, drawing, and abstract as a whole.

The current invention disclosure discloses a specially designed pacifier that has a built-in Bluetooth device and memory device for the storage of data. The data can be in the form of music, poems, literature, or a parent's voice.

It is a primary objective of the current invention to provide comfort to a baby via a pacifier that is capable of playing music, tunes, stories, and a parent's pre-recorded voice for the baby.

It is yet another objective of the invention to provide a pacifier that can store stories, music, poems, and a parent's voice to increase learning by activation of auditory stimulus in an infant/baby.

It is also an objective of the invention to provide a pacifier that has Bluetooth capabilities to make the transfer of information easy, fast, and convenient.

It is also an objective of the present invention to provide a pacifier that is comprised of waterproof material.

It is also an objective of the present invention to provide a clean and safe baby pacifier.

Another objective of the present invention is to provide a pacifier whose cover is not easily removable by children.

It is therefore, an objective of the present invention to provide a new and improved pacifier that has all of the advantages of the prior art pacifiers, and none of the disadvantages.

It is a further objective of the present invention to provide a new and improved pacifier that is of a durable and reliable construction.

Other objectives of the invention will become apparent to those skilled in the art once the invention has been shown and described. These objectives are not to be construed as limitations of the applicant's invention, but are merely aimed to suggest some of the many benefits that may be realized by the apparatus of the present application and with its many embodiments. In addition to the various objectives and advantages of the present invention, described with some degree of specificity above, it should be obvious that additional objectives and advantages of the present invention, will become more readily apparent to those persons who are skilled in the relevant art from the following more detailed description of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1: shows the top view of the pacifier.

FIG. 2: shows the side view of the pacifier.

FIG. 3: shows the mouth side view of the pacifier.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and, together with the description, serve to explain the principles of the invention.

An improved baby pacifier including a replaceable nipple, a handle, and a cover that locks into place with a tilt, snap, and twist motion is disclosed. The pacifier includes a sealing plug to remove-ably secure the nipple to the main body and to seal the nipple filling inside of the nipple.

The pacifier further includes means for the baby to suck. The sucking means preferably includes a hollow flexible nipple that opens at only one end into a receiving cavity.

The present invention disclosure discloses a pacifier that is specially customized to provide soothing and comforting feelings to a child via an integrated audio system that is capable of playing music, poems, stories, a parent's voice, or any other person's voice that the child is familiar of.

In the past, various attempts have been made to devise an apparatus or create a pacifier that is capable of comforting a child as quickly as possible.

In order to provide the solution to this problem, the current invention discloses a specially customized pacifier that is capable of invoking an auditory stimulus in a child and also increase the learning capabilities of said child. The pacifier disclosed herein plays music or any data in the form of audio once it is ON.

The main advantage of this pacifier is that it can store a variety of data in audio form that can be changed by the user from time to time via a Bluetooth device that is integrated within the pacifier.

Reference now will be made in detail to the present preferred embodiments of the invention. Examples of these are illustrated in the accompanying drawings.

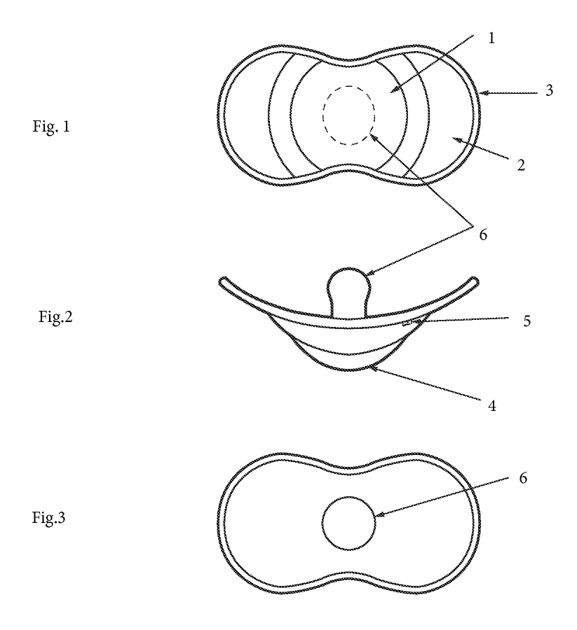

FIGS. 1 to 3 illustrate preferred embodiments of the present invention, which are designated generally by the numerals. The pacifier is comprised of two different surfaces: namely a centrally located round surface outside of the rubber button that is designated as hard compartment 1. The surface outside of the hard compartment, labelled as numeral, can be made of soft, rubber-like flexible material, and may have a variety of colors and patterns placed on it 2. This surface is lined by a thin lining of rubber, labelled as rubber edge 3. The pacifier is provided with a rubber button 4 that is placed in the center of the pacifier body as it shown in FIG. 2. This rubber button is the control switch S to turn the Bluetooth ON/OFF.

Irrespective of the control switch, i.e. the rubber button that is placed on to pacifier surface, the pacifier audio system is activated when a sensor senses the touch of child when the child starts using the pacifier.

FIG. 3 shows the pacifier and nipple assembly, wherein the said nipple 6 is de-attachable and can be removed from the pacifier when it is worn out or becomes infective. Hence, the improved baby pacifier disclosed herein is provided with a reusable, disposable, and waterproof nipple.

The pacifier has an integrated Bluetooth device 6 that enables the reception of data from any other activated Bluetooth source.

The pacifier is rechargeable and may be powered with a battery or any other electric power source.

Therefore, the pacifier disclosed herein is not only a comforting device for a child, but also a learning aid.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Although specific terms are used in this specification, these terms are for convenience of description, and are not the limitation of the present invention in any combination.

Although the invention has been explained in relation to its preferred embodiment, it is to be understood that many other possible modifications and variations can be made without departing from the spirit and scope of the invention.

It is to be understood that the above description is intended to be illustrative, and not restrictive.

I claim:

1. A pacifier that provides soothing and comforting feelings to a child, the pacifier comprises:
a hard compartment;
a surface outside the hard compartment;
a nipple assembly; and
an integrated auditory system.

2. The pacifier according to claim 1, wherein said hard compartment is a centrally located round surface outside a control switch.

3. The pacifies according to claim 2, wherein said control switch is a rubber button.

4. The pacifier according to claim 1, wherein said surface outside said hard compartment is made of soft rubber-like flexible material.

5. The pacifier according to claim 1, wherein said surface outside said hard compartment has a variety of colors and patterns placed on it.

6. A pacifier with nipple assembly comprises:
an interchangeable nipple;
a handle;
a cover; and
a sealing plug.

7. The pacifier according to claim 6, wherein said interchangeable nipple is removed when it is worn out or becomes ineffective.

8. The pacifier according to claim 6, wherein said interchangeable nipple is waterproof.

9. The pacifier according to claim 6, wherein said interchangeable nipple is disposable.

10. The pacifier according claim 6, wherein said cover locks into place with a tilt, snap, and twist motion.

11. The pacifier according to claim 6, wherein said sealing plug removably secures said interchangeable nipple to the main body.

12. The pacifier according to claim 6, wherein said sealing plug further seals a nipple filling inside of said interchangeable nipple.

13. A pacifier with integrated auditory system comprises:
means for data storage;
an audio player;
means for sensing touch of the child.

14. The pacifier according to claim 13, wherein said means for data storage stores the data in audio form.

15. The pacifier according to claim 14, wherein the data stored in audio form is music or poems or stories or a parent's voice or any other person's voice.

16. The pacifier according to claim 13, wherein said means for sensing touch of the child is a sensor.

17. The pacifier according to claim 13 or 16, wherein said audio player plays the data in audio form when the sensor senses the touch of the child.

18. The pacifier according to claim 1, wherein said integrated auditory system also increases the learning capabilities of the child.

19. The pacifier according to claim 1, wherein said integrated auditory system invokes an auditory stimulus in a child.

20. The pacifier according to claim 1, wherein said integrated auditory system provides soothing and comforting feelings to the child.

21. The pacifier of claim 1, further comprises an integrated Bluetooth device.

22. The pacifier according to claim 21, wherein the control switch turns the integrated Bluetooth device ON or OFF.

23. The pacifier according to claim 14 or 21, wherein the integrated Bluetooth device allows exchange of the data stored in audio form.
